(19) United States
(12) Patent Application Publication
(10) Pub. No.: US 2026/0357047 A1
(43) Pub. Date: Nov. 12, 2026

(54) RUBBER COMPOSITIONS AND ARTICLES THEREOF

(71) Applicant: The Goodyear Tire & Rubber Company, Akron, OH (US)

(72) Inventors: Claude Charles Jacoby, Wasserbillig (LU); Manuela Pompei, Reuler (LU); Laurence Isabelle Joly, Hobscheid (LU); Tobias Karl-Fridolin Dier, Wincheringen (LU)

(21) Appl. No.: 19/190,979

(22) Filed: Apr. 28, 2025

(51) Int. Cl. C08L 15/00; B60C 1/00

(52) U.S. Cl. CPC C08L 15/00; B60C 1/00; C08L 2312/00

(57) ABSTRACT

In one aspect, the disclosure relates to compositions, comprising: a polydiene in the amount of about 75 phr to about 100 phr, wherein the polydiene comprises one or more elastomers, and wherein at least one elastomer has a glass transition temperature of from about −95 °C to about −75 °C; at least about 5 phr of a coupling agent comprising a blocked mercapto silane; and at least about 40 phr of a resin, where the resin comprises an ester of resin acid and a polyhydric alcohol. The disclosure also relates to articles comprising the disclosed compositions, such as tires or components of tires. This abstract is intended as a scanning tool for purposes of searching in the particular art and is not intended to be limiting of the present disclosure.

### BACKGROUND

The demand for improved tire performance has resulted in the evaluation of materials that have desirable properties. Improving tire properties while maintaining the balance in trade-offs can be challenging. For example, for all-season tires and winter tires, desirable properties include good wet traction performance, low rolling resistance, and snow and/or ice performance. However, keeping one property, e.g., snow performance, at a good level without sacrificing another property, e.g., wet traction performance, has traditionally been very difficult. Despite improvements in rubber formulations for tires such as all-season tires and winter tires, there is a need for rubber formulations that maintain a balance in performance for desirable properties such as wet traction, rolling resistance, and snow and/or ice performance. These needs and other needs are satisfied by the present disclosure.

### SUMMARY

In accordance with the purpose(s) of the disclosure, as embodied and broadly described herein, the disclosure, in one aspect, relates to compositions, comprising: a polydiene in the amount of about 75 phr to about 100 phr, wherein the polydiene comprises one or more elastomers, and wherein at least one elastomer has a glass transition temperature of from about −95 °C to about −75 °C; at least about 5 phr of a coupling agent comprising a blocked mercapto silane; and at least about 40 phr of a resin, where the resin comprises an ester of resin acid and a polyhydric alcohol. The disclosure also relates to articles comprising the disclosed compositions, such as tires or components of tires.

Other systems, methods, features, and advantages of the present disclosure will be or become apparent to one with skill in the art upon examination of the following detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### DETAILED DESCRIPTION

Many modifications and other aspects disclosed herein will come to mind to one skilled in the art to which the disclosed compositions and methods pertain having the benefit of the teachings presented in the foregoing descriptions. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the composition statutory class, this is for convenience only and one of skill in the art will understand that each aspect of the present disclosure can be described and claimed in any statutory class.

Although specific terms are employed herein, they are used in a generic and descriptive sense only and not for purposes of limitation. It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “an elastomer,” “an accelerator,” or “a wax,” includes, but is not limited to, two or more such elastomers, accelerators, or waxes, and the like. Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical compound, where the molecules may or may not be identical (e.g., different isotopic ratios, enantiomers, and the like).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

The terms “rubber” and “elastomer” may be used herein interchangeably, unless indicated otherwise.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In one aspect, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In one aspect, rubber compositions can be cured in molds in order to form finished articles such as tires.

As used herein, the term “repeat unit” as referenced in the elastomers described herein are derived from monomers used to produce the partially saturated elastomers. For example, polybutadiene has the repeat unit as provided below.

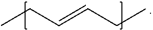

In certain aspects, when the elastomer is the polymerization product of two different monomers (e.g., A and B), the repeat unit can be represented by -A-B-.

As used herein, a “residue” of a chemical species refers to the moiety that is the resulting product of the chemical species in a particular reaction scheme or subsequent formulation or chemical product, regardless of whether the moiety is actually obtained from the chemical species. Thus, an isoprene residue in an elastomer refers to one or more-CH₂CH═C(CH₃)CH₂— units in the elastomer, regardless of whether isoprene was used to prepare the elastomer. Similarly, a butadiene residue in an elastomer refers to one or more-CH₂CH═CHCH₂— moieties in the elastomer, regardless of whether the residue is obtained by reacting sebacic acid or an ester thereof to obtain the polyester.

The term “tread,” refers to both the region of a tire that comes into contact with the road under normal inflation and load as well as any subtread.

The glass transition temperature (T_{g}) of an elastomer or elastomer composition is the glass transition temperature(s) of the respective elastomer or elastomer composition in its uncured state or possibly a cured state in a case of an elastomer composition. T_{g} values of elastomers are determined as a peak midpoint by a differential scanning calorimeter (DSC) at a temperature rate of increase of 10 °C per minute, in accordance with ASTM D3418-21. The T_{g} for a resin is determined as a peak midpoint by a DSC at a temperature rate of increase of 10 °C per minute, in accordance with ASTM D6604-00 (2017). The T_{g} for an oil is determined as a peak midpoint by a DSC at a temperature rate of increase of 10 °C per minute, in accordance with ASTM E1356-08 (2014).

Unless otherwise specified, temperatures referred to herein are based on atmospheric pressure (i.e. one atmosphere).

### B. RUBBER COMPOSITIONS

In one aspect, the disclosure relates to compositions, such as vulcanizable rubber compositions and cured vulcanizable rubber compositions, comprising a polydiene in the amount of about 75 phr to about 100 phr, at least about 5 phr of a coupling agent comprising a blocked mercapto silane; and at least about 40 phr of a resin. In a further aspect, the polydiene can comprise one or more elastomers, wherein at least one elastomer has a glass transition temperature of from about −95 °C to about −75 °C. In another further aspect, the resin can comprise an ester of a resin acid and a polyhydric alcohol. In one aspect, the disclosure relates to articles, such as tires and/or components of tires, comprising the compositions and/or cured forms of the compositions. In another aspect, tires comprising the disclosed compositions can exhibit a good balance between wet traction performance, snow performance (e.g., traction on snowy and/or icy surfaces), and rolling resistance. The rubber compositions are not limited to use in tires but can also find application in other articles such as rubber gloves, surgical instruments, and the like.

In a further aspect, the composition can comprise from about 75 phr, about 80 phr, about 85 phr, about 90 phr, about 95 phr, or about 100 phr of the polydiene, where any value can be a lower and upper endpoint of a range (e.g., about 80 phr to about 100 phr). In another aspect, at least one elastomer of the polydiene can have a glass transition temperature of about −95 °C, about −90 °C, about −85 °C, about −80 °C, or about −75 °C, where any value can be a lower and upper endpoint of a range (e.g., about −90 °C to about −80 °C). In another aspect, the polydiene can comprise polybutadiene rubber, a solution polymerized styrene-butadiene rubber (SSBR), or a combination thereof. Any of the elastomers included in the polydiene can individually have a number average molecular weight (Mₙ) between 100,000 Da and 500,000 Da. Mₙ may be determined by methods known in the art, such as by gel permeation chromatography following ASTM D3536 or an equivalent.

In another aspect, at least one elastomer can be functionalized with at least one functional group. The functional groups can be appended to the polymer chain at a terminus or within the elastomer chain. Functional groups can be incorporated into the elastomer during polymerization (e.g., as a functional polymerization initiator or functional polymerization terminator for terminal appendage) or as a functional moiety for in-chain insertion. In one aspect, at least one elastomer (e.g., a solution polymerized styrene-butadiene rubber) can be functionalized with at least one functional group selected from an aminosilane group, a thiol, a hydroxy, an ethoxy group, an epoxy group, an amino group, a carboxyl group, a phthalocyanine group, and a silane-sulfide group. Examples of aminosilane groups include, but are not limited to, mono-; bis-; tris-; or tetra-(alkylamino) alkenylmethylsilanes; (alkenylamino) alkenylmethylsilanes; (alkylamino) halomethylsilanes; (alkenylamino) halomethylsilanes; (arylamino) alkenylmethylsilanes; and (arylamino) halomethylsilanes. In another aspect, at least one elastomer (e.g., a polybutadiene rubber) can be functionalized with at least one functional group selected from hydroxy, thiol, an amino group, an alkoxy group, an alkoxyamine group, a silane, an alkoxysilane, and an alkoxyaminosilane.

In one aspect, the polydiene can comprise a solution polymerized styrene-butadiene rubber having from about 2 wt %, about 4 wt %, about 6 wt %, about 8 wt %, or about 10 wt % residues of styrene, where any value can be a lower and upper endpoint of a range (e.g., about 2 wt % to about 10 wt %). Styrene content refers to the wt % of bound styrene in a polymer and can be determined by Fourier Transform infrared spectroscopy. In another aspect, the polydiene consists of or consists essentially of the solution polymerized styrene-butadiene rubber. In another aspect, the polydiene can comprise the solution polymerized styrene-butadiene rubber from about 25 phr, about 30 phr, about 35 phr, about 40 phr, about 45 phr, about 50 phr, about 55 phr, about 60 phr, about 65 phr, about 70 phr, about 75 phr, about 80 phr, about 85 phr, about 90 phr, about 95 phr, or about 100 phr, where any value can be a lower and upper endpoint of a range (e.g., about 55 phr to about 90 phr).

In another aspect, the polydiene can comprise polybutadiene rubber having a cis-1,4-butadiene content of greater than or equal to 90%, greater than about 93%, greater than about 95%, or greater than about 97%. In another aspect, the polydiene can comprise polybutadiene rubber having a cis-1,4-butadiene content of 90%, about 92%, about 94%, about 96%, about 98%, about 99%, or about 100%, where any value can be a lower and upper endpoint of a range (e.g., 90% to about 99%). In another aspect, the polydiene can consist of or consist essentially of a polybutadiene rubber. A polybutadiene rubber having a cis-1,4-butadiene content of 90% or greater can be referred to as a high-cis polybutadiene. In another aspect, the polydiene can comprise polybutadiene rubber having a cis-1,4-butadiene content of less than about 40%, less than about 37%, less than about 35%, or less than about 32%. In another aspect, the polydiene can comprise polybutadiene rubber having a cis-1,4-butadiene content of about 30%, about 32%, about 34%, about 36%, about 38%, or about 40%, where any value can be a lower and upper endpoint of a range (e.g., 32% to about 38%). Cis, trans, and vinyl contents (%) of polymers refer to the molar proportions of the 1,4-cis, 1-4-trans, and 1-2-vinyl butadiene units of the polymer, unless otherwise expressed. These percentages can be determined by solid-state NMR. In another aspect, the polydiene can comprise polybutadiene rubber from about 10 phr, about 15 phr, about 20 phr, about 25 phr, about 30 phr, about 35 phr, about 40 phr, about 45 phr, about 50 phr, about 55 phr, about 60 phr, about 65 phr, about 70 phr, about 75 phr, about 80 phr, about 85 phr, about 90 phr, about 95 phr, or about 100 phr where any value can be a lower and upper endpoint of a range (e.g., about 10 phr to about 75 phr). In a further aspect, the polydiene can comprise a high-cis polybutadiene rubber from about 10 phr, about 15 phr, about 20 phr, about 25 phr, about 30 phr, about 35 phr, about 40 phr, or about 45 phr, where any value can be a lower and upper endpoint of a range (e.g., about 10 phr to about 45 phr). In another further aspect, the polydiene can comprise a polybutadiene rubber with a cis-1,4-butadiene content of less than about 40% from about 50 phr, about 55 phr, about 60 phr, about 65 phr, about 70 phr, about 75 phr, about 80 phr, about 85 phr, about 90 phr, about 95 phr, or about 100 phr where any value can be a lower and upper endpoint of a range (e.g., about 60 phr to about 75 phr).

As disclosed previously, the resin can comprise an ester of a resin acid and a polyhydric alcohol (i.e., the reaction product between the resin acid and the polyhydric alcohol). In one aspect, the composition can comprise at least about 40 phr, at least about 50 phr, or at least about 60 phr of a resin. In another aspect, the composition can comprise about 40 phr, about 50 phr, about 60 phr, about 70 phr, about 80 phr, or about 90 phr of a resin, where any value can be a lower and upper endpoint of a range (e.g., about 40 phr to about 80 phr). In another aspect, the resin can have a glass transition temperature of about 20 °C, about 30 °C, about 40 °C, about 50 °C, about 60 °C, about 70 °C, or about 80 °C, where any value can be a lower and upper endpoint of a range (e.g., about 20 °C to about 80 °C). In another aspect, the resin can have a softening point of about 50 °C, about 60 °C, about 70 °C, about 80 °C, about 90 °C, about 100 °C, about 110 °C, about 120 °C, or about 130 °C, where any value can be a lower and upper endpoint of a range (e.g., about 90 °C to about 110 °C). The softening point of the resin can be determined by Kraton Test Method (AQCM) 003, ASTM D465, or an equivalent. In a further aspect, the resin can be significantly bio-based, where the resin comprises from about 85%, about 90%, about 95%, about 99%, or about 100% bio-based resin, where any value can be a lower and upper endpoint of a range (e.g., about 90% to about 95%). Using a bio-based resin can allow for production of a more environmentally sustainable rubber composition. The resin can include gum rosins from the oleoresin extrudate of the living pine tree, wood rosins from the oleoresin contained in the aged stumps, tall oil rosins from the waste carboxyl group to the liquor recovered as a by-product in the Kraft paper industry, derivatives thereof, or combinations thereof.

In one aspect, the resin acid of can include a fused tricyclic compound with at least one carboxylic acid group and at least one double bond. In a further aspect, the resin acid can comprise abietic acid, dehydroabietic acid, levopimaric acid, palustric acid, neoabietic acid, pimaric acid, isopimaric acid, or any combination thereof.

The polyhydric alcohol can be any organic compound possessing two or more hydroxyl groups. In one aspect, the polyhydric alcohol can comprise ethylene glycol, propylene glycol, diethylene glycol, triethylene glycol, tetraethylene glycol, trimethylene glycol, pentaerythritol, dipentaerythritol, tripentaerythritol, trimethylolethane, trimethylolpropane, mannitol, sorbitol, or any combination thereof.

In another aspect, the resin can further comprise an ester of a fatty acid and a polyhydric alcohol (i.e., the reaction product between the fatty acid and the polyhydric alcohol). In one aspect, the fatty acid can comprise palmitic acid, stearic acid, behenic acid, or any combination thereof. In another aspect, the resin comprises (1) an ester of pentaerythritol and dehydroabietic acid and levopimaric acid and (2) an ester of pentaerythritol and palmitic acid, stearic acid, and behenic acid.

The compositions described herein can include one or more optional resins. In one aspect, the optional resins can include aromatic or nonaromatic hydrocarbon resins. The hydrocarbon resins can also have various degrees of unsaturation or be fully saturated. In one aspect, the resins can be derived from C5 alkenes and/or C9 alkenes. In one aspect, the composition comprises a C5 aliphatic resin, a C9 aromatic resin, dicyclopentadiene (DCPD), a hydrogenated dicyclopentadiene (HDCPD), a copolymer thereof (e.g., a copolymer of DCPD and a C9 aromatic resin (CDPC/C9) or a copolymer of HCPD and a C9 aromatic resin (HDCPD/C9)), or any combination thereof. In one aspect, the hydrocarbon resin can be functionalized and/or partially hydrogenated. The hydrocarbon resin, such as a C5/C9 resin, (e.g., DCPD/C9 or HDCPD/C9 resin) can have an aromatic hydrogen content, as determined by ¹H NMR, of about 5 mol %, about 10 mol %, about 15 mol %, about 20 mol %, or about 25 mol %, with the balance being aliphatic hydrogen content, where any value can be a lower and upper endpoint of a range (e.g., about 5 mol % to about 15 mol %). In another aspect, the hydrocarbon resin can have a softening point of about 80 °C, about 90 °C, about 100 °C, about 110 °C, or about 120 °C, as determined by ASTM E28 (ring and ball softening point), where any value can be a lower and upper endpoint of a range (e.g., about 90 °C to about 110 °C). In another aspect, the composition does not include dicyclopentadiene or a hydrogenated dicyclopentadiene.

The coupling agent can be about 5 phr, about 10 phr, about 15 phr, or about 20 phr of the composition, where any value can be a lower and upper endpoint of a range (e.g., about 5 phr to about 20 phr). The blocked mercapto silane is a silane compound possessing at least one blocked thiol group (i.e., the hydrogen atom of the thiol group (—SH) has been replaced with an organic group). Examples of blocked mercapto silanes include, but are not limited to, an alkoxysilylalkylthio compound or an alkylalkoxysilylalkylthio compound blocked with an acetate group, a phosphonate group, a phosphinate group, a sulfate group, a sulfonate group, an alkanoate group, a palmitate group, a benzoate group, and mixtures thereof. In one aspect, the coupling agent comprises 3-octanoylthio-1-propyltriethoxy silane, 3-octanoylthiopropyl-1-trimethoxysilane, or a combination thereof. The composition can comprise additional organosilane coupling agents, such as mercapto silanes, other blocked mercapto silanes, trialkoxymercaptoalkyl silanes, derivatives thereof, or combinations thereof. Mercapto silanes can include compounds such as 3-mercaptopropyl trialkoxy silanes, 3-mercaptopropyl dialkoxy (alkoxy) silanes, 3-mercaptoethyl trialkoxy silanes, or 3-mercaptoethyl dialkoxy (alkoxy) silanes, where the alkoxy groups can be a C1-C5 or C1-C3 alkoxy.

In one aspect, one or more of the coupling agent(s) can be added to the rubber composition in the form of a pre-treated silica. The pre-treated silica can be one that has been pre-surface treated with an organosilane prior to being added to the rubber composition. The use of a pre-treated silica can allow for two ingredients (i.e., silica and a silica coupling agent) to be added as one ingredient, which may make rubber compounding easier and may also reduce the amount of organosilane coupling agent needed. In another embodiment, the coupling agent(s) is/are separately added to the rubber composition.

The composition can further comprise a filler, a fatty acid, a wax, a liquid plasticizer, an antidegradant, or any combination thereof. The filler can comprise carbon black, a silica, or a combination thereof. In a further aspect, the composition can comprise from about 50 phr, about 100 phr, about 150 phr, or about 200 phr of the silica, where any value can be a lower and upper endpoint of a range (e.g., about 50 phr to about 200 phr). In another further aspect, the composition can comprise from about 1 phr, about 2 phr, about 3 phr, about 4 phr, or about 5 phr of carbon black, where any value can be a lower and upper endpoint of a range (e.g., about 1 phr to about 5 phr). Fatty acids can be included in amounts of, for example, about 0.5 phr to about 3 phr. Examples of fatty acids include, but are not limited to, stearic acid, palmitic acids, oleic acid, and mixtures thereof. In another aspect, waxes can be included in amounts of about 1 phr to about 5 phr. Examples of waxes include microcrystalline waxes, paraffin waxes, and isoparaffin waxes.

Liquid plasticizers can include both an extending oil present in the elastomers and a process oil added during compounding. Liquid plasticizers can be included in the composition in amounts of about 0.5 phr to about 10 phr. Suitable processing oils include, but are not limited to, various oils as are known in the art, including aromatic, paraffinic, naphthenic, vegetable oils, and low PCA oils, such as MES, TDAE, SRAE, and heavy naphthenic oils. Suitable vegetable oils include, for example, soybean oil, sunflower oil, and canola oil which are in the form of esters containing a certain degree of unsaturation. Antidegradants can be included in the composition in amounts of about 0.1 phr to about 5 phr. Antidegradants can include antioxidants and antiozonants. Representative antidegradants include, but are not limited to, phenylene diamine compounds (e.g., diphenyl-p-phenylenediamine, N-phenyl-N′-(1,3-dimethylbutyl)-p-phenylenediamine (6PPD), N,N′-dixylene-p-phenylenediamine (DTPD)), hydroquinoline compounds, amine compounds, dithiocarbamate compounds, phenolic compounds, phosphite compounds, toluimidazole compounds, and others, such as those disclosed in The Vanderbilt Rubber Handbook (1978), Pages 344 through 346.

The silica can include precipitated silica. Precipitated silicas can be obtained, for example, by the acidification of a soluble silicate, e.g., sodium silicate. The silica can be characterized by its surface area. One method of measuring the surface area of silica is nitrogen adsorption in accordance with ASTM D1993-18, which is referred to herein as nitrogen surface area. The nitrogen surface area of the silica can range from about 110 m²/g to about 400 m²/g. The carbon black can include an n-type carbon black. Examples of N-type carbon black include those with ASTM designations N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991, as specified by ASTM D1765-21. These carbon blacks can be characterized as having iodine absorptions, as determined according to ASTM D1510-21, ranging from about 9 g/kg to about 145 g/kg. These carbon blacks can also be characterized as having a dibutyl phthalate (DBP) absorption number, as determined according to ASTM D2414, ranging from about 34 cm³/100 g to about 150 cm³/100 g.

In another aspect, the composition can further comprise curing aids (e.g., activators, accelerators, retarders), curing or vulcanizing agents, or a combination thereof. Activators can be included in amounts of about 0.1 phr to about 10 phr or about 1 phr to about 5 phr. Activators can include, but are not limited to, magnesium oxide, zinc oxide, calcium oxide, and polyethylene glycol. Other examples of cure activators include stearic acid, palmitic acid, lauric acid, zinc salts of each of the foregoing, and thiourea compounds such as thiourea and dihydrocarbylthioureas (e.g., dialkylthioureas and diarylthioureas). Accelerators and retarders can be individually included in amounts of about 0.1 phr to about 10 phr. Accelerators can include, but are not limited to, sulfenamide compounds (e.g., N-cyclohexyl-2-benzothiazolesulfenamide and N-tertbutyl-2-benzothiazolesulfenamide), guanidine compounds (e.g., diphenylguanidine, N,N′-diphenyl guanidine), dithiocarbamate compounds, thiadiazol compounds, thiazole compounds, thiourea compounds, thiuram compound, and xanthate compounds. Retarders can include, but are not limited to, phthalic anhydrides, phthalimides (e.g., N-(cyclohexylthio) phthalimide), sulfenamide compounds, and acids (e.g., benzoic acid and salicylic acid). Vulcanizing agents can be included in amounts of about 0.1 phr to about 8.0 phr or about 0.1 phr to about 5.0 phr. The curing or vulcanizing agents can include, but are not limited to, elemental sulfur, insoluble polymeric sulfur, soluble sulfur, and sulfur donating vulcanizing agents (for example, an amine disulfide, polymeric polysulfide, sulfur olefin adduct), and combinations thereof.

### C. PREPARATION AND APPLICATIONS OF RUBBER COMPOSITIONS

Rubber compositions can be compounded by methods generally known in the rubber compounding art. In one aspect, methods for compounding rubber can include mixing a polydiene, a coupling agent, and a resin together with, optionally, various vulcanizable constituent rubbers and with, optionally, various commonly used additive materials such as: fillers, fatty acids, waxes, liquid plasticizers, antidegradants, curing aids, and curing or vulcanizing agents, as disclosed and described herein. In one aspect, the components can be combined in two or more mixing steps.

This disclosure also provides for articles that incorporate any of the vulcanized rubber compositions disclosed herein or are produced by any of the methods disclosed herein. In one aspect, the article comprises a tire, such as a pneumatic tire, or a component of a tire. The tire can be a race tire, passenger tire, aircraft tire, agricultural tire, off-the-road tire, truck or bus tire, or the like. The tire can also be a radial or bias. The component of the tire can be a tread, base, sidewall, apex, chafer, sidewall insert, overlay, wirecoat, innerliner, or a combination thereof. Such tires can be built, shaped, molded, and cured by various methods which are known and will be readily apparent to those having skill in such art.

When used to form a tire or component of a tire, such as tire tread of a pneumatic tire, the rubber composition disclosed herein can provide a balanced combination of wet traction performance, rolling resistance, and snow and/or ice performance, as determined by various indicators for these characteristics. Further discussion of these indicators can be found in the Examples. Wet traction is a tire's ability to stop on wet surfaces, such as pavement. Rolling resistance is the energy that a vehicle needs to send to the tires to maintain movement at a consistent speed over a surface and thus can impact the fuel efficiency of the vehicle. Snow and/or ice performance relates to the tire's ability to stop on snow and icy surfaces, such as pavement. In one aspect, the disclosed compositions can produce tires, and/or components of tires, where the tires exhibit better snow performance, comparable wet traction performance, and comparable rolling resistance compared to an equivalent tire that does not comprise the disclosed resin and/or comprises a resin with no bio-based content (e.g., a C5 aliphatic resin, a C9 aromatic resin, DCPD, HDCPD, a copolymer thereof, or any combination thereof) in place of the disclosed resin. In another aspect, the disclosed compositions comprising a polydiene including both a polybutadiene rubber and SSBR can produce tires, and/or components of tires, where the tires exhibit better snow performance and comparable rolling resistance compared to an equivalent tire that does not comprise a polybutadiene rubber.

In one aspect, rubber compositions can be prepared by mixing the vulcanizable elastomers, filler (e.g., silica), and other rubber compounding ingredients, not including the curing agent, in at least one sequential mixing stage with at least one mechanical mixer, usually referred to as a “non-productive” mixing stage, or stage(s), to an elevated temperature under high shear rubber mixing conditions, followed by a final “productive” mixing stage, in which a sulfur-based cure package, including, for example, a sulfur-based curing agent and other curing aids (e.g., accelerators), are added to the mixture and mixed at a lower mixing temperature. The ingredients may be mixed in the non-productive mixing stage(s), for example, for about 2 minutes to a temperature of about 130 °C to about 200 °C (e.g., about 145 °C). Once the cure package is added (or at least the curing agent), the subsequent productive mixing step may be conducted at a temperature below the vulcanization (cure) temperature and/or for a short time, in order to avoid unwanted pre-cure of the rubber composition. In one aspect, the productive mixing step can be conducted at a temperature of no more than 120 °C, such as at least about 40 °C or at least about 60 °C (e.g., for about 2 minutes to a temperature of about 110 to about 115 °C). Mixing may be performed, for example, by kneading the ingredients together in a Banbury mixer or on a milled roll. The rubber composition may be cooled to a temperature below 40 °C between each of the mixing stages. For example, the rubber composition may be dumped from the mixer after each mixing step, sheeted out from an open mill or sheeted out by a roller die, and allowed to cool to below 40 °C after each mixing step.

When the cure package is thoroughly mixed, the rubber composition may be molded or otherwise formed into the shape of a green component of a tire, such as a tire tread. The temperature of the green component may be raised to effect cure. Curing of the pneumatic tire or a part/component thereof may be carried out at a temperature of from about 120 °C to about 200 °C (e.g., at least 140 °C, no more than 180 °C, or about 150 °C) for at least about 10 minutes. Any of the usual vulcanization processes may be used, such as heating in a press or mold, or heating with superheated steam or hot air.

### D. ASPECTS

The following listing of exemplary aspects supports and is supported by the disclosure provided herein.

Aspect 1. A vulcanizable composition, comprising: a polydiene in the amount of about 75 phr to about 100 phr, wherein the polydiene comprises one or more elastomers, and wherein at least one elastomer has a glass transition temperature of from about −95 °C to about −75 °C; at least about 5 phr of a coupling agent comprising a blocked mercapto silane; and at least about 40 phr of a resin, where the resin comprises an ester of resin acid and a polyhydric alcohol.

Aspect 2. The vulcanizable composition of aspect 1, wherein the resin acid comprises a fused tricyclic compound with at least one carboxylic acid group and at least one double bond.

Aspect 3. The vulcanizable composition of aspect 1 or 2, wherein the resin acid comprises abietic acid, dehydroabietic acid, levopimaric acid, palustric acid, neoabietic acid, pimaric acid, isopimaric acid, or any combination thereof.

Aspect 4. The vulcanizable composition of any one of aspects 1-3, wherein the resin further comprises an ester of a fatty acid ester of a polyhydric alcohol.

Aspect 5. The vulcanizable composition of aspect 4, wherein the fatty acid comprises palmitic acid, stearic acid, behenic acid, or any combination thereof.

Aspect 6. The vulcanizable composition of any one of aspects 1-5, wherein the polyhydric alcohol comprises ethylene glycol, propylene glycol, diethylene glycol, triethylene glycol, tetraethylene glycol, trimethylene glycol, pentaerythritol, dipentaerythritol, tripentaerythritol, trimethylolethane, trimethylolpropane, mannitol, sorbitol, or any combination thereof.

Aspect 7. The vulcanizable composition of aspect 1, wherein the resin comprises (1) an ester of pentaerythritol and dehydroabietic acid and levopimaric acid and (2) an ester of pentaerythritol and palmitic acid, stearic acid, and behenic acid.

Aspect 8. The vulcanizable composition of any one of aspects 1-7, wherein the resin has a glass transition temperature of from about 20 °C to about 80 °C.

Aspect 9. The vulcanizable composition of any one of aspects 1-8, wherein the polydiene comprises polybutadiene rubber, a solution polymerized styrene-butadiene rubber, or a combination thereof.

Aspect 10. The vulcanizable composition of any one of aspects 1-8, wherein the polydiene comprises the solution polymerized styrene-butadiene rubber having from about 2 wt % to about 10 wt % residues of styrene.

Aspect 11. The vulcanizable composition of any one of aspects 1-10, wherein the polydiene comprises a polybutadiene rubber having a cis-1,4-butadiene content of less than about 40%.

Aspect 12. The vulcanizable composition of any one of aspects 1-10, wherein the polydiene comprises a polybutadiene rubber having a cis-1,4-butadiene content of about 30% to about 40%.

Aspect 13. The vulcanizable composition of any one of aspects 1-10, wherein the polydiene comprises a polybutadiene rubber having a cis-1,4-butadiene content of greater than or equal to 90%.

Aspect 14. The vulcanizable composition of any one of aspects 1-10, wherein the polydiene comprises a polybutadiene rubber having a cis-1,4-butadiene content of 90% to about 99%.

Aspect 15. The vulcanizable composition of any one of aspects 1-14, wherein the polydiene comprises the polybutadiene rubber from about 10 phr to about 75 phr and the solution polymerized styrene-butadiene rubber from about 25 phr to about 90 phr.

Aspect 16. The vulcanizable composition of any one of aspects 1-15, wherein at least one elastomer is functionalized with at least one functional group selected from an aminosilane group, a thiol, a hydroxy, an ethoxy group, an epoxy group, an amino group, a carboxyl group, a phthalocyanine group, and a silane-sulfide group.

Aspect 17. The vulcanizable composition of any one of aspects 1-15, wherein the solution polymerized styrene-butadiene rubber is functionalized with at least one functional group selected from an aminosilane group, a thiol, a hydroxy, an ethoxy group, an epoxy group, an amino group, a carboxyl group, a phthalocyanine group, and a silane-sulfide group.

Aspect 18. The vulcanizable composition of any one of aspects 1-17, wherein at least one elastomer is functionalized with at least one functional group selected from a hydroxy, a thiol, an amino group, an alkoxy group, an alkoxyamine group, a silane, an alkoxysilane, and an alkoxyaminosilane.

Aspect 19. The vulcanizable composition of any one of aspects 1-17, wherein the polybutadiene rubber is functionalized with at least one functional group selected from a hydroxy, a thiol, an amino group, an alkoxy group, an alkoxyamine group, a silane, an alkoxysilane, and an alkoxyaminosilane.

Aspect 20. The vulcanizable composition of any one of aspects 1-19, wherein the coupling agent comprises 3-octanoylthio-1-propyltriethoxy silane, 3-octanoylthiopropyl-1-trimethoxysilane, or a combination thereof.

Aspect 21. The vulcanizable composition of any one of aspects 1-20, wherein the coupling agent is from about 5 phr to 20 phr and wherein the resin is from about 40 phr to about 80 phr.

Aspect 22. The vulcanizable composition of any one of aspects 1-21, wherein the composition further comprises a C5 aliphatic resin, a C9 aromatic resin, dicyclopentadiene, a hydrogenated dicyclopentadiene, a copolymer thereof, or any combination thereof.

Aspect 23. The vulcanizable composition of any one of aspects 1-21, wherein the composition does not include dicyclopentadiene or a hydrogenated dicyclopentadiene.

Aspect 24. The vulcanizable composition of any one of aspects 1-23, wherein the composition further comprises a filler, a fatty acid, a wax, a liquid plasticizer, an antidegradant, or any combination thereof.

Aspect 25. The vulcanizable composition of aspect 24, wherein the filler comprises carbon black, a silica, or a combination thereof.

Aspect 26. The vulcanizable composition of any one of aspects 1-25, wherein the composition comprises from about 50 phr to about 200 phr of the silica.

Aspect 27. The vulcanizable composition of any one of aspects 1-26, wherein the composition comprises from about 1 phr to about 5 phr of carbon black.

Aspect 28. A vulcanized composition comprising the vulcanizable composition of any one of aspects 1-27, wherein the vulcanizable composition has been cured.

Aspect 29. An article comprising the vulcanized composition of aspect 28.

Aspect 30. The article of aspect 29, wherein the article comprises a tire or a component of a tire.

Aspect 31. The article of aspect 30, wherein the component of the tire comprises a tread, base, sidewall, apex, wirecoat, ply coat, shoulder wedge, chafer, or any combination thereof.

Aspect 32. The article of aspect 30, wherein the component of the tire comprises a tread.

From the foregoing, it will be seen that aspects herein are well adapted to attain all the ends and objects hereinabove set forth together with other advantages which are obvious and which are inherent to the structure. While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text, there is no intent to limit aspects of the present disclosure to this description. On the contrary, the intent is to cover all alternatives, modifications, and equivalents included within the spirit and scope of the present disclosure.

### E. EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

### 1. Evaluation of Rubber Compositions

Four rubber compositions comprising an SSBR-based matrix are provided in Table 1. Notable differences between the compositions include whether polybutadiene is included in the mixture and what type of traction resin is used. The control compositions (C1, C2, and C3) use HDCPD as the traction resin, while the compositions as described herein (I1, I2, and I3) use a bio-based traction resin. C1 is the control composition for I1, C2 is the control composition for I2, and C3 is the control composition for I3. All control and inventive compositions comprise the same and equal amounts of wax, antidegradants, aids and curatives (not shown).

Briefly, the rubber compositions are prepared as follows: In a first non-productive step (NP1), the ingredients labeled as used in mixing step NP1 (see Table 1) are combined in a lab-scale mixer and mixed until a temperature of about 160 °C is achieved. The mixing continues at this temperature for 1-2 minutes. The mixture is then dropped from the mixer and allowed to cool. Thereafter, in a productive mixing step (PR), the remaining ingredients (labeled with PR in Table 1) are added and the mixing continues until the temperature reaches about 115 °C. The vulcanizable composition is then cured at about 170 °C and formed into strips suitable for testing.

TABLE 1
Rubber composition with amounts of each component shown in phr.

| | Mixing | | | | | | |
|---|---|---|---|---|---|---|---|
| Ingredient | Step | C1 | C2 | C3 | I1 | I2 | I3 |
| Polybutadiene¹ | NP1 | 22 | 0 | 0 | 22 | 0 | 0 |
| Polybutadiene² | NP1 | 0 | 0 | 73 | 0 | 0 | 73 |
| SSBR³ | NP1 | 81.12 | 104 | 28.08 | 81.12 | 104 | 28.08 |
| Silica⁴ | NP1 | 150 | 150 | 150 | 150 | 150 | 150 |
| Coupling Agent⁵ | NP1 | 12 | 12 | 12 | 12 | 12 | 12 |
| Liquid Plasticizer⁶ | NP1 | 6 | 6 | 7 | 6 | 6 | 7 |
| Processing Aid | NP1 | 3 | 3 | 3 | 3 | 3 | 3 |
| Traction Resin⁷ | NP1 | 66 | 66 | 67 | 0 | 0 | 0 |
| Gum rosin⁸ | NP1 | 3 | 3 | 3 | 3 | 3 | 3 |
| Bio-based | NP1 | 0 | 0 | 0 | 66 | 66 | 67 |
| Traction Resin⁹ | | | | | | | |
| Accelerator¹⁰ | PR | 6.5 | 6.5 | 6.0 | 6.7 | 6.7 | 6.5 |
| Specific Gravity | N/A | 1.25 | 1.25 | 1.25 | 1.25 | 1.25 | 1.25 |

¹Solution polymerized, high cis-1,4 polybutadiene stabilized with a non-staining antioxidant; produced using a stereospecific neodymium catalyst which controls molecular weight distribution and provides a highly linear polymer; Mooney viscosity (ML1 + 4 at 100 °C) of 55; T_{g} of −106 °C; onset T_{g} of −110 °C; cis-1,4 butadiene content, 96-97 wt. %; volatiles, 0.5 wt. % maximum; specific gravity 0.91; obtained as BUDENE ® 1223, from The Goodyear Tire and Rubber Company.
²Polybutadiene rubber functionalized for the coupling to silica and having a T_{g} of −90.5 °C and vinyl content of 14.5% and cis content of 34.5%; obtained as KBR 820 from Kumho.
³Li-catalyzed, aminosiloxane multi-functionalized, solution polymerized, styrene butadiene rubber; 5 wt. % styrene; 11% 1,2-vinyl; less than 40% cis-1,4 butadiene; given phr includes 3.85 wt. % extender oil; Mooney viscosity (ML1 + 4 at 100 °C) of 90; T_{g} of −85 °C; obtained as M0511 ™ from LG Chemicals.
⁴Precipitated silica having a BET nitrogen surface area of about 125 m2/g; a CTAB surface area of about 115 m2/g; obtained as Hi-Sil ™ 315 G-D from PPG.
⁵3-Octanoylthio-1-propyltriethoxysilane, obtained as NXT ™ silane, from Momentive Performance Materials.
⁶Vegetable oil (sunflower oil).
⁷Hydrogenated dicyclopentadiene (HDCPD)/C9 resin; 10 wt. % aromatic content; 89 wt. % aliphatic; softening point (ring and ball method), about 103 °C; T_{g}, 55 °C; Mn 480 g/mol; Mw 770 g/mol; obtained as OPPERA ™ PR 383 from ExxonMobil.
⁸WW grade Gum Rosin (colophony); softening point (ring and ball method) of about 85 °C; obtained from A.V. Pound & Co. Ltd.
⁹Sylvatraxx ™ 2097 from Kraton
¹⁰Mixture of N-cyclohexyl benzothiazole-2-sulfenamide (CBS) and N,N′-diphenyl guanidine (DPG)

After curing, the rubber compositions are formed into appropriately-sized samples (based on the testing methodology used) and subjected to various tests. The tests for the various rheological properties were performed on rubber samples that were cured at 170 °C for 10 minutes. Testing results are presented in Table 2. Generally, performance tests show that using a bio-based traction resin in place of HDCPD (I1, I2, and I3) results in significant improvements in snow performance, improvements in wet traction performance, and comparable rolling resistance.

TABLE 2
Performance testing of cured rubber compositions.

| Property | C1 | C2 | C3 | I1 | I2 | I3 |
|---|---|---|---|---|---|---|
| Rebound (%) | 15.8 | 16.1 | 18.2 | 13.8 | 14.5 | 16.8 |
| at 0 °C | | | | | | |
| RPA Tan δ | 0.142 | 0.151 | 0.140 | 0.138 | 0.147 | 0.137 |
| (10%) at 100 | | | | | | |
| °C | | | | | | |
| E′ (MPa) | 406 | 583 | 349 | 318 | 417 | 276 |
| at −50 °C | | | | | | |

Rebound was determined using a Zwick Roell 5109 rebound resilience tester in accordance with DIN 53512 or ASTM D1054. Rebound at 0 °C can be used as an indicator of wet traction performance, where lower values indicate better wet traction. All of I1, I2, and I3 exhibited better wet traction performance compared to their corresponding control compositions.

Tan δ of Table 2 is measured at a strain amplitude of 10% at a temperature of 100 °C. A rubber process analyzer (RPA2000 from Alpha Technologies) was used to determine Tan δ. Tan δ can be used as an indicator of rolling resistance, where lower values typically correspond to a better (i.e., lower) rolling resistance. All of I1, I2, and I3 exhibit similar rolling resistances compared to their corresponding control compositions.

Eplexor (E′) is determined by means of a GABO Eplexor tester. The test specimen is subjected to 0.25% sinusoidal deformation at 1 Hz and the temperature is varied. The test method is similar to that described in ISO 6721. E′ at −50 °C can be used as an indicator of snow performance (e.g., traction on snowy and/or icy surfaces), where lower values indicate better snow performance. All of I1, I2, and I3 exhibited significantly better snow traction performance compared to their corresponding control compositions.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A vulcanizable composition, comprising:
a polydiene in the amount of about 75 phr to about 100 phr, wherein the polydiene comprises one or more elastomers, and wherein at least one elastomer has a glass transition temperature of from about −95 °C to about −75 °C;
at least about 5 phr of a coupling agent comprising a blocked mercapto silane; and
at least about 40 phr of a resin, where the resin comprises an ester of a resin acid and a polyhydric alcohol.

2. The vulcanizable composition of claim 1, wherein the resin acid comprises a fused tricyclic compound with at least one carboxylic acid group and at least one double bond.

3. The vulcanizable composition of claim 1, wherein the resin acid comprises abietic acid, dehydroabietic acid, levopimaric acid, palustric acid, neoabietic acid, pimaric acid, isopimaric acid, or any combination thereof.

4. The vulcanizable composition of claim 1, wherein the resin further comprises an ester of a fatty acid and a polyhydric alcohol.

5. The vulcanizable composition of claim 4, wherein the fatty acid comprises palmitic acid, stearic acid, behenic acid, or any combination thereof.

6. The vulcanizable composition of claim 1, wherein the polyhydric alcohol comprises ethylene glycol, propylene glycol, diethylene glycol, triethylene glycol, tetraethylene glycol, trimethylene glycol, pentaerythritol, dipentaerythritol, tripentaerythritol, trimethylolethane, trimethylolpropane, mannitol, sorbitol, or any combination thereof.

7. The vulcanizable composition of claim 1, wherein the polydiene comprises a solution polymerized styrene-butadiene rubber having from about 2 wt % to about 10 wt % residues of styrene.

8. The vulcanizable composition of claim 1, wherein the polydiene comprises a polybutadiene rubber having a cis-1,4-butadiene content of less than about 40%.

9. The vulcanizable composition of claim 1, wherein the polydiene comprises a polybutadiene rubber having a cis-1,4-butadiene content of greater than or equal to 90%.

10. The vulcanizable composition of claim 1, wherein the polydiene comprises polybutadiene rubber from about 10 phr to about 75 phr and a solution polymerized styrene-butadiene rubber from about 25 phr to about 90 phr.

11. The vulcanizable composition of claim 1, wherein at least one elastomer is functionalized with at least one functional group selected from an aminosilane group, a thiol, a hydroxy, an ethoxy group, an epoxy group, an amino group, a carboxyl group, a phthalocyanine group, and a silane-sulfide group.

12. The vulcanizable composition of claim 1, wherein at least one elastomer is functionalized with at least one functional group selected from a hydroxy, a thiol, an amino group, an alkoxy group, an alkoxyamine group, a silane, an alkoxysilane, and an alkoxyaminosilane.

13. The vulcanizable composition of claim 1, wherein the resin comprises (1) an ester of pentaerythritol and dehydroabietic acid and levopimaric acid and (2) an ester of pentaerythritol and palmitic acid, stearic acid, and behenic acid.

14. The vulcanizable composition of claim 1, wherein the coupling agent comprises 3-octanoylthio-1-propyltriethoxy silane, 3-octanoylthiopropyl-1-trimethoxysilane, or a combination thereof.

15. The vulcanizable composition of claim 1, wherein the coupling agent is from about 5 phr to about 20 phr and wherein the resin is from about 40 phr to about 80 phr.

16. The vulcanizable composition of claim 1, wherein the composition further comprises a C5 aliphatic resin, a C9 aromatic resin, dicyclopentadiene, a hydrogenated dicyclopentadiene, a copolymer thereof, or any combination thereof.

17. The vulcanizable composition of claim 1, wherein the composition further comprises a filler, a fatty acid, a wax, a liquid plasticizer, an antidegradant, or any combination thereof.

18. A vulcanized composition comprising the vulcanizable composition of claim 1, wherein the vulcanizable composition has been cured.

19. An article comprising the vulcanized composition of claim 18.

20. The article of claim 19, wherein the article comprises a tire or a component of a tire.
